(19) United States
(12) Patent Application Publication
(10) Pub. No.: US 2004/0072011 A1
(43) Pub. Date: Apr. 15, 2004

(54) Electroless brass plating method and product-by-process

(75) Inventors: Carlos Dominguez-Rios, Chihuahua (MX); Alfredo Aguilar-Elguezabal, Mexicano (MX); Myriam Moreno-Lopez, Miguel de Cervantes (MX); Silvia Miranda-Navarro, Miguel de Cervantes (MX)

Correspondence Address: LAW OFFICE OF JAY R. YABLON, 910 NORTHUMBERLAND DRIVE, SCHENECTADY, NY, 12309-2814, US

(73) Assignee: Centro de Investigaciq Materiales Avanzados, S.C., Chihuahua (MX)

(21) Appl. No.: 10/065,369

(22) Filed: Oct. 10, 2002

(51) Int. Cl. B05D 3/10; B05D 1/18; B32B 15/04

(52) U.S. Cl. 428/615; 427/304; 427/437; 428/626; 428/457; 428/469; 428/936

(57) ABSTRACT

An electroless brass plating method for applying an uniform and thick metallic layer on metallic, ceramic or plastic pieces, which does not depend on the piece geometry nor on its electric characteristics and by which global costs are reduced approximately 50% thanks to the use of a zinc compound as source of zinc atoms, which is less expensive than zinc cyanide.

### BACKGROUND OF INVENTION

The present invention is related to brass-plating methods, and more particularly to an electro less brass plating method for metallic, plastic and ceramic pieces by which an homogeneous brass plating layer can be applied without the application of an electric current.

Plating methods are related to the application of metallic layers for modifying the appearance or the surface properties of the objects treated by said methods, such as abrasion resistance, strength, etc.

Two of the most common methods for plating metallic pieces are based on watery solutions of metallic salts, which form the metallic layer.

The first method consists in the electrolytic deposition of metals in suspension which are found in cationic form, and the second one consists in an autocatalytic (electroless) method, in which the metallic cover is deposited by means of special additives.

The above referred methods, are not only limited only to the deposition of pure metals, but also for the deposition of an extensive variety of metal alloys, on metallic, plastic and ceramic materials pieces.

Originally, the plating methods were developed for decorative purposes, but, nowadays the plating is mainly used for protecting materials against corrosion and abrasion or even for increasing the hardness of some materials.

The method for the deposition of saline metallic solutions may be considered as a chemical reduction reaction, which is opposite to the metallic oxidation, as in the case of iron surfaces when attacked by atmospheric oxygen and humidity, which transform the metallic iron to ferric oxide (Fe₂O₃). The reduction is an electrochemical method in which the electrons are trapped by the metal, and by which a full valence band is obtained. This reaction is represented as follows:

$$\begin{matrix}{Me}^{Z +} + ze {⟷}_{Oxidation}^{Reduction} Me & & Z = valence number\end{matrix} \qquad ( 1 )$$

There are two broadly used methods for covering metals with other kinds of metal, which are known as electroplating and electrolytic plating (auto catalytic) methods. In both methods, an aqueous medium is used, due to the high solubility of metal salts, and of the good conductivity of the aqueous medium.

The electrolytic deposition of metals is based on the cathodic discharge of metallic ions during the electrolysis of a metallic saline solution. The metallic ions are reduced to pure metals on the cathode, which performs as an electron source and the anode performs as an electrons exit.

As represented by equation 2, the electrons required for the oxidation reduction reaction—come from an external electric source.

Me^{z+}z+ze→Me (2)

When sacrifice anodes are used, is possible to achieve the inverse reaction as represented in equation 3.

Me→Me^{z+}+ze (3)

In the electrolytic plating method, the electrons required for obtaining the metallic ion reduction on the substratum surface are not obtained from an electric external source but from a chemical reaction in the aqueous solution. This mechanism can be considered strictly as a chemical deposition.

According to Gawrilov, the auto catalytic method may be classified as:

a) Deposition by ion interchange or charge interchange (replace reaction, cementation, or plating by immersion).

b) Deposition by contact of the metal to be plated with an aqueous solution of metallic salts of the same metal or of different metals.

c) Metal deposition from a solution containing reductor agents.

It is desirable to develop an electro-less substitute for the electrolytic method. By such a method the following benefits are obtained:

One can plate metallic, ceramic or plastic pieces.

On can obtain a homogeneous metallic layer independently of the piece geometry and of its electric characteristics.

The method of the present invention is faster than the conventional electrolytic method thanks to a reduction in method steps compared with the conventional methods.

The covering costs are reduced approximately a 50% thanks to the use of a zinc compound which is used as a source of zinc atoms, which is less expensive than zinc cyanide.

The method of the present invention does not use an external electricity source as source of electrons, thus reducing the method cost.

It can be used for covering steel, aluminum or any other metallic alloy piece.

It is therefore a main object of the present invention to provide an electroless brass plating method for metallic, ceramic and plastic pieces by which is obtained an homogeneous metallic layer that does not depend on the piece geometry nor on its electric characteristics like is the case of the electrolytic method.

It is another object of the present invention to provide a method of the above referred nature, which is faster than the conventional electrolytic methods thanks to the reduction of steps compared with the conventional methods.

It is a further object of the present invention to provide a method of the above referred nature by which the covering costs are reduced approximately 50% thanks to the use of a zinc compound as source of zinc atoms, which is less expensive than zinc cyanide.

It is still a main object of the present invention to provide a method from the above referred nature which does not use an external energy source as source of electrons, thus reducing global costs.

It is another object of the present invention to provide a method of the above referred nature which can be used for covering steel and aluminum pieces or any other metallic alloy.

This and other objects and other advantages of the present invention will become apparent to those persons with ordinary skills on the art, from the following detailed description of the invention.

### SUMMARY OF INVENTION

The plating method in accordance with the present invention, is related to the metal deposition using a solution containing reductor agents. The method of the present invention can be used as a substitute of the electrolytic method because an uniform and thick and durable metallic layer can be obtained. The deposition is applied on surfaces considered to be as catalytically actives. The electrons required for reducing metallic ions are obtained from the reductive agent Rⁿ⁺ which is surrounded by z electrons. This reductor agent is oxidized to R^{(n+z)} according to reactions 4 and 5.

Rⁿ⁺→R^{(n+z)}+ze (4)

Me^{z+}+ze→Me (5)

The electroless brass-plating method for providing a brass layer to a metallic piece comprises the steps of: submitting the piece to an alkaline degrease; performing a first rinsing to the piece; submitting the piece to a cathodic degrease; performing a second rinsing to the piece; submitting the piece to an electroless brass-plating for providing a brass layer on the piece's surface, by submerging the piece in a solution containing: oxide zinc, as source of zinc atoms, copper cyanide as source of copper atoms, a complexing agent, a buffer type substance and a pH controller; performing a third rinsing; submitting the piece to a fixing treatment for fixing the brass layer to the piece's surface and drying the piece.

The electroless brass-plating method for providing a brass layer to a ceramic or plastic piece comprises the steps of: submitting the piece to an alkaline degrease; performing a first rinsing to the piece; submitting the piece to an electroless brass-plating for providing a brass layer on the piece's surface, by submerging the piece in a solution containing: oxide zinc, as source of zinc atoms, copper cyanide as source of copper atoms, a complexing agent, a buffer type substance and a pH controller; performing a second rinsing; submitting the piece to a fixing treatment for fixing the brass layer to the piece's surface and drying the piece.

Also encompassed are the metallic, ceramic, and brass pieces (product) produced by the above-summarized methods (processes).

### DETAILED DESCRIPTION

The method of the present invention comprises the following steps:

carrying out a medium intensity alkaline degrease by submerging the piece to be plated in a solution having 23 g/lt of sodium carbonate and 23 g/lt of trisodic phosphate for at least 2 minutes under continue stirring. The solution must be at a temperature of between 75° C. to 90° C. The pieces to be plated must be as clean as possible and free of greases. The oxides deposited on the surface always cause adhesion problems and/or color changes that cannot be controlled. The typical values for a medium intensity alkaline degrease are shown in the following table:

| | | |
|---|---|---|
| Sodium Carbonate | Na₂CO₃ | 18-28 g/lt |
| Trisodic phosphate | Na₃PO₄ 12H₂O | 18-28 g/lt |
| Temperature | | 70-85° C. |
| Stirring | | Constant |
| Residence Time | | 3 min |

carrying out a first rinsing by submerging the piece in a countercurrent water stream at ambient temperature during at least 1 minute;

If the piece being treated is metallic, then a cathodic degrease must be carried out firstly by submerging the metallic piece in an alkaline bath with a sodium hydroxide solution at 2% for a time no longer than 60 seconds under constant stirring. The piece to be treated performs the function of the anode and an stainless steel or graphite rod performs the function of the cathode. A direct current is applied having a density of between about 3 to 5 amp/dm². The bath temperature must be at ambient temperature. The typical composition values and operation conditions for the cathodic degrease are shown in the following table:

| | | |
|---|---|---|
| Sodium Hydroxide | NaOH | 15-25 g/lt |
| Temperature | | Ambient |
| Current Density | Direct Current | 3-5 Amp/dm² |
| Stirring | | Constant |
| Residence Time | | 40-60 s |
| Electrod | | Stainless steel or graphite |
| | | rod |

submitting the piece to a rinsing after the cathodic degrease has been carried out by submerging the piece in a countercurrent water stream at ambient temperature during at least 1 minute;

submitting the piece to a non electrolytic brass plating treatment by submerging the piece in a bath having the following composition:

| | | |
|---|---|---|
| Sodium Hydroxide | NaOH | 27-30 g/lt |
| Sodium Cyanide | NaCN | 47-58 g/lt |
| Zinc Oxide | ZnO | 18-22 g/lt |
| Copper Cyanide | Cu(CN)₂ | 32-37 g/lt |
| Sodium Carbonate | Na₂CO₃ | 13-17 g/lt |
| Rochelle Salt | NaK(C₄H₄O₆) 4H₂O | 18-22 g/lt |
| Amonia | NH₄OH | 10 ml/lt |

The bath must be at a temperature of between about 40 C to 80 C having a Ph >11. The residence time of the pieces in the solution must be of approximately 5 to 25 minutes, preferably between 10 to 15 minutes in order to obtain a layer having a thickness of approximately 5 to 7 μm. During the residence time of the piece in the solution, a constant stirring must be applied in order to assure that only fresh solution contacts the piece surface. The preferred operation conditions are shown in the following table:

| Temperature | 55-65° C. |
|---|---|
| Residence Time | 10-15 min |
| Shaking | Constant |
| pH | >11 |

submitting the piece to a rinsing after the non electrolytic brass plating has been carried out by submerging the piece in a countercurrent water stream at ambient temperature during at least 1 minute;

submitting the piece to a fixing bath In order to fix the brass cover (copper-zinc) to the piece surface, said fixing bath including an acid solution such as boric acid at a concentration of between 7 to 27 g/lt, preferably between 15 to 19 g/lt, having a pH lower than 5, preferably of 4, and a temperature between 35° C. to 75° C., preferably between 45 and 60° C.

The residence time of the piece in the fixing solution must be of 10 to 45 minutes, preferably of 20 to 30 minutes under constant stirring. It must be guaranteed that the sites where the brass-plating treatment and the fixing bath treatment are carried out, be completely separated from each other, since highly poisonous compounds may be formed if the chemicals used in both treatments are combined.

drying the pieces by exposing the piece to a countercurrent air current at ambient temperature during at least a minute;

Although it has been described that the drying step is carried out by exposing the piece to an air current, it can also be applied a moderate heat to the piece. It is also possible to leave the pieces in the open air until all traces of humidity disappear.

The use of the Rochelle's Salt as complexing agent and/or reducer agent of zinc and copper ions provide a shinier finish to the treated surfaces.

It is to be understood that brass-plated pieces (products) produced by the above-disclosed method (by-process) are also considered to be within the scope of this disclosure and its associated claims. As stated earlier, these products produced by this process have a thicker, more uniform, more durable layer than is achievable by conventional processes, and, of course, it is not even possible to plate ceramic and plastic pieces by conventional processes. As such, the products produced by this process have desirable inherent characteristics that cannot be achieved through conventional plating processes.

Finally it must be understood that the electroless brass-plating method of the present invention, is not limited exclusively to the above described and illustrated embodiments and that the persons having ordinary skill in the art can, with the teaching provided by this invention, to make modifications to the steps of the method of the present invention, which will clearly be within the true inventive concept and scope of the invention which is claimed in the following claims.

1. An electroless brass-plating method for providing a brass layer to a metallic piece comprising the steps of:
submitting the piece to an alkaline degrease;
performing a first rinsing to the piece;
submitting the piece to a cathodic degrease;
performing a second rinsing to the piece;
submitting the piece to an electroless brass-plating for providing a brass layer on the piece's surface, by submerging the piece in a solution containing: oxide zinc, as source of zinc atoms, copper cyanide as source of copper atoms, a complexing agent, a buffer type substance and a pH controller;
performing a third rinsing;
submitting the piece to a fixing treatment for fixing the brass layer to the piece's surface and
drying the piece.

2. The method as claimed in claim 1, wherein the alkaline degrease is carried out by submerging the piece in a solution having 23 g/lt of sodium carbonate and 23 g/lt of trisodic phosphate at a temperature of between 75° C. and 90° C. for at least 2 minutes under constant stirring.

3. The method as claimed in claim 1, wherein the alkaline degrease is carried out by submerging the piece in a solution having between 18 and 28 g/lt of sodium carbonate and between 18 and 28 g/lt of trisodic phosphate at a temperature of between 70° C. and 85° C. for 3 minutes under constant stirring.

4. The method as claimed in claim 1, wherein the first rinsing is carried out by submerging the piece in a countercurrent water stream at ambient temperature during at least 1 minute.

5. The method as claimed in claim 1, wherein the cathodic degrease is carried out by submerging the piece for a time no longer than 60 seconds in a sodium hydroxide solution at 2% at ambient temperature and applying a current of 3 to 5 Amp/dm² under constant stirring, and wherein the piece performs the function of an anode and a stainless steel metal rod performs the function of a cathode.

6. The method as claimed in claim 1, wherein the cathodic degrease is carried out by submerging the piece for a time no longer than 60 seconds in a sodium hydroxide solution at 2% at ambient temperature and applying a current of 3 to 5 Amp/dm² under constant stirring, and wherein the piece performs the function of an anode and a graphite rod performs the function of a cathode.

7. The method of the claim 1, wherein the cathodic degrease is carried out by submerging the piece for a time of between 40 and 60 seconds in a solution containing 15 to 25 g/lt of sodium hydroxide at ambient temperature and applying a current of 3-5 Amp/dm² under constant stirring, and wherein the piece performs the function of an anode and a stainless steel rod performs the function of a cathode.

8. The method of the claim 1, wherein the cathodic degrease is carried out by submerging the piece for a time of between 40 and 60 seconds in a solution containing 15 to 25 g/lt of sodium hydroxide and applying a current of 3 to 5 Amp//dm² under constant stirring, and wherein the piece performs the function of an anode and a graphite rod performs the function of a cathode.

9. The method as claimed in claim 1, wherein the first rinsing is carried out by submerging the piece in a countercurrent water stream at ambient temperature during at least 1 minute.

10. The method as claimed in claim 1, wherein in the electroless brass-plating step, the complexing agent comprises a Rochelle's salt.

11. The method as claimed in claim 1, wherein in the electroless brass-plating step the bath contains from 27 to 30 g/lt of sodium hydroxide, from 47 to 58 g/lt of sodium cyanide, from 18 to 22 g/lt of zinc oxide, from 32 to 37 g/lt of copper cyanide, from 13 to 17 g/lt of sodium carbonate, from 18 to 22 g/lt of Rochelle's salt and from 10 ml/It of ammonia.

12. The method as claimed in claim 1, wherein in the electroless brass-plating the solution must be at a temperature of between 40° C. and 80° C.

13. The method as claimed in claim 1, wherein in the electroless brass-plating step, the solution must be at a temperature of between 55° C. and 65° C.

14. The method as claimed in claim 1, wherein in the electroless brass-plating step, the pieces must be submerged in the solution for a time of 5 to 25 minutes.

15. The method as claimed in claim 1, wherein in the electroless brass-plating step, the pieces must be submerged in the solution for a time of 10 to 15 minutes.

16. The method as claimed in claim 1, wherein in the electroless brass-plating step, the solution is constantly stirred.

17. The method as claimed in claim 1, wherein in the electroless brass-plating step, the solution has a pH higher than 11.

18. The method as claimed in claim 1, wherein the third rinsing is carried out by submerging the piece in a countercurrent water stream at ambient temperature during at least 1 minute.

19. The method as claimed in claim 1, wherein the fixing treatment comprises submerging the piece in an acid solution containing boric acid at a concentration of between 7 to 27 g/lt having a pH lower than 5, and at a temperature of between 35° C. and 75°, for a time of 10 to 45 minutes under constant stirring.

20. The method as claimed in claim 1, wherein the fixing treatment comprises submerging the piece in an acid solution containing boric acid at a concentration of between 15 to 19 g/lt, having a pH lower than 4, and at a temperature of between 45 to 60° C., for a time of 20 to 30 minutes under constant stirring.

21. The method as claimed in claim 1, wherein the drying is carried out by exposing the piece to an air current at ambient temperature for at least 1 minute.

22. The method as claimed in claim 1, wherein the brass layer has a thickness of from 5 to 7 μm.

23. An electroless brass-plating method for providing a brass layer to a ceramic or plastic piece comprising the steps of:
submitting the piece to an alkaline degrease;
performing a first rinsing to the piece;
submitting the piece to an electroless brass-plating for providing a brass layer on the piece's surface, by submerging the piece in a solution containing: oxide zinc, as source of zinc atoms, copper cyanide as source of copper atoms, a complexing agent, a buffer type substance and a pH controller;
performing a second rinsing;
submitting the piece to a fixing treatment for fixing the brass layer to the piece's surface and
drying the piece.

24. The method as claimed in claim 23, wherein the alkaline degrease is carried out by submerging the piece in a solution having 23 g/lt of sodium carbonate and 23 g/lt of trisodic phosphate at a temperature of between 75° C. and 90° C. for at least 2 minutes under constant stirring.

25. The method as claimed in claim 23, wherein the alkaline degrease is carried out by submerging the piece in a solution having between 18 and 28 g/lt of sodium carbonate and between 18 and 28 g/lt of trisodic phosphate at a temperature of between 70° C. and 85° C. for 3 minutes under constant stirring.

26. The method of the claim 23, wherein the first rinsing is carried out by submerging the piece in a countercurrent water stream at ambient temperature during at least 1 minute.

27. The method as claimed in claim 23, wherein in the electroless brass-plating step, the complexing agent comprises a Rochelle's salt.

28. The method as claimed in claim 23, wherein in the electroless brass-plating step the bath contains from 27 to 30 g/lt of sodium hydroxide, from 47 to 58 g/lt of sodium cyanide, from 18 to 22 g/lt of zinc oxide, from 32 to 37 g/lt of copper cyanide, from 13 to 17 g/lt of sodium carbonate, from 18 to 22 g/lt of Rochelle's salt and from 10 ml/It of ammonia.

29. The method as claimed in claim 23, wherein in the electroless brass-plating the solution must be at a temperature of between 40° C. and 80° C.

30. The method as claimed in claim 23, wherein in the electroless brass-plating step, the solution must be at a temperature of between 55° C. and 65° C.

31. The method as claimed in claim 23, wherein in the electroless brass-plating step, the pieces must be submerged in the solution for a time of 5 to 25 minutes.

32. The method as claimed in claim 23, wherein in the electroless brass-plating step, the pieces must be submerged in the solution for a time of 10 to 15 minutes.

33. The method as claimed in claim 23, wherein in the electroless brass-plating step, the solution is constantly stirred.

34. The method as claimed in claim 23, wherein in the electroless brass-plating step, the solution has a pH higher than 11.

35. The method as claimed in claim 23, wherein the second rinsing is carried out by submerging the piece in a countercurrent water stream at ambient temperature during at least 1 minute.

36. The method as claimed in claim 23, wherein the fixing treatment comprises submerging the piece in an acid solution containing boric acid at a concentration of between 7 to 27 g/lt having a pH lower than 5, and at a temperature of between 35° C. and 75, for a time of 10 to 45 minutes under constant stirring.

37. The method as claimed in claim 23, wherein the fixing treatment comprises submerging the piece in an acid solution containing boric acid at a concentration of between 15 to 19 g/lt, having a pH lower than 4, and at a temperature of between 45 to 60° C., for a time of 20 to 30 minutes under constant stirring.

38. The method as claimed in claim 23, wherein the drying is carried out by exposing the piece to an air current at ambient temperature for at least 1 minute.

39. The method as claimed in claim 23, wherein the brass layer has a thickness of from 5 to 7 μm.

40. A brass-plated metallic piece product, produced using an electroless brass-plating process for providing a brass layer to said metallic piece, said process comprising the steps of:
submitting the piece to an alkaline degrease;
performing a first rinsing to the piece;
submitting the piece to a cathodic degrease;
performing a second rinsing to the piece;
submitting the piece to an electroless brass-plating for providing a brass layer on the piece's surface, by submerging the piece in a solution containing: oxide zinc, as source of zinc atoms, copper cyanide as source of copper atoms, a complexing agent, a buffer type substance and a pH controller;
performing a third rinsing;
submitting the piece to a fixing treatment for fixing the brass layer to the piece's surface and
drying the piece.

41. The product-by-process as claimed in claim 40, wherein the alkaline degrease is carried out by submerging the piece in a solution having 23 g/lt of sodium carbonate and 23 g/lt of trisodic phosphate at a temperature of between 75° C. and 90° C. for at least 2 minutes under constant stirring.

42. The product-by-process as claimed in claim 40, wherein the alkaline degrease is carried out by submerging the piece in a solution having between 18 and 28 g/lt of sodium carbonate and between 18 and 28 g/lt of trisodic phosphate at a temperature of between 70° C. and 85° C. for 3 minutes under constant stirring.

43. The product-by-process as claimed in claim 40, wherein the first rinsing is carried out by submerging the piece in a countercurrent water stream at ambient temperature during at least 1 minute.

44. The product-by-process as claimed in claim 40, wherein the cathodic degrease is carried out by submerging the piece for a time no longer than 60 seconds in a sodium hydroxide solution at 2% at ambient temperature and applying a current of 3 to 5 Amp/dm² under constant stirring, and wherein the piece performs the function of an anode and a stainless steel metal rod performs the function of a cathode.

45. The product-by-process as claimed in claim 40, wherein the cathodic degrease is carried out by submerging the piece for a time no longer than 60 seconds in a sodium hydroxide solution at 2% at ambient temperature and applying a current of 3 to 5 Amp/dm² under constant stirring, and wherein the piece performs the function of an anode and a graphite rod performs the function of a cathode.

46. The product-by-process of the claim 40, wherein the cathodic degrease is carried out by submerging the piece for a time of between 40 and 60 seconds in a solution containing 15 to 25 g/lt of sodium hydroxide at ambient temperature and applying a current of 3-5 Amp/dm² under constant stirring, and wherein the piece performs the function of an anode and a stainless steel rod performs the function of a cathode.

47. The product-by-process of the claim 40, wherein the cathodic degrease is carried out by submerging the piece for a time of between 40 and 60 seconds in a solution containing 15 to 25 g/lt of sodium hydroxide and applying a current of 3 to 5 Amp//dm² under constant stirring, and wherein the piece performs the function of an anode and a graphite rod performs the function of a cathode.

48. The product-by-process as claimed in claim 40, wherein the first rinsing is carried out by submerging the piece in a countercurrent water stream at ambient temperature during at least 1 minute.

49. The product-by-process as claimed in claim 40, wherein in the electroless brass-plating step, the complexing agent comprises a Rochelle's salt.

50. The product-by-process as claimed in claim 40, wherein in the electroless brass-plating step the bath contains from 27 to 30 g/lt of sodium hydroxide, from 47 to 58 g/lt of sodium cyanide, from 18 to 22 g/lt of zinc oxide, from 32 to 37 g/lt of copper cyanide, from 13 to 17 g/lt of sodium carbonate, from 18 to 22 g/lt of Rochelle's salt and from 10 ml/lt of ammonia.

51. The product-by-process as claimed in claim 40, wherein in the electroless brass-plating the solution must be at a temperature of between 40° C. and 80° C.

52. The product-by-process as claimed in claim 40, wherein in the electroless brass-plating step, the solution must be at a temperature of between 55° C. and 65° C.

53. The product-by-process as claimed in claim 40, wherein in the electroless brass-plating step, the pieces must be submerged in the solution for a time of 5 to 25 minutes.

54. The product-by-process as claimed in claim 40, wherein in the electroless brass-plating step, the pieces must be submerged in the solution for a time of 10 to 15 minutes.

55. The product-by-process as claimed in claim 40, wherein in the electroless brass-plating step, the solution is constantly stirred.

56. The product-by-process as claimed in claim 40, wherein in the electroless brass-plating step, the solution has a pH higher than 11.

57. The product-by-process as claimed in claim 40, wherein the third rinsing is carried out by submerging the piece in a countercurrent water stream at ambient temperature during at least 1 minute.

58. The product-by-process as claimed in claim 40, wherein the fixing treatment comprises submerging the piece in an acid solution containing boric acid at a concentration of between 7 to 27 g/lt having a pH lower than 5, and at a temperature of between 35° C. and 75°, for a time of 10 to 45 minutes under constant stirring.

59. The product-by-process as claimed in claim 40, wherein the fixing treatment comprises submerging the piece in an acid solution containing boric acid at a concentration of between 115 to 19 g/lt, having a pH lower than 4, and at a temperature of between 45 to 60° C., for a time of 20 to 30 minutes under constant stirring.

60. The product-by-process as claimed in claim 40, wherein the drying is carried out by exposing the piece to an air current at ambient temperature for at least 1 minute.

61. The product-by-process as claimed in claim 40, wherein the brass layer has a thickness of from 5 to 7 μm.

62. A brass-plated ceramic or plastic piece product, produced using an electroless brass-plating method for providing a brass layer to said ceramic or plastic piece, said process comprising the steps of:
submitting the piece to an alkaline degrease;
performing a first rinsing to the piece;
submitting the piece to an electroless brass-plating for providing a brass layer on the piece's surface, by submerging the piece in a solution containing: oxide zinc, as source of zinc atoms, copper cyanide as source of copper atoms, a complexing agent, a buffer type substance and a pH controller;
performing a second rinsing;
submitting the piece to a fixing treatment for fixing the brass layer to the piece's surface and
drying the piece.

63. The product-by-process as claimed in claim 62, wherein the alkaline degrease is carried out by submerging the piece in a solution having 23 g/lt of sodium carbonate and 23 g/lt of trisodic phosphate at a temperature of between 75° C. and 90° C. for at least 2 minutes under constant stirring.

64. The product-by-process as claimed in claim 62, wherein the alkaline degrease is carried out by submerging the piece in a solution having between 18 and 28 g/lt of sodium carbonate and between 18 and 28 g/lt of trisodic phosphate at a temperature of between 70° C. and 85° C. for 3 minutes under constant stirring.

65. The product-by-process of the claim 62, wherein the first rinsing is carried out by submerging the piece in a countercurrent water stream at ambient temperature during at least 1 minute.

66. The product-by-process as claimed in claim 62, wherein in the electroless brass-plating step, the complexing agent comprises a Rochelle's salt.

67. The product-by-process as claimed in claim 62, wherein in the electroless brass-plating step the bath contains from 27 to 30 g/lt of sodium hydroxide, from 47 to 58 g/lt of sodium cyanide, from 18 to 22 g/lt of zinc oxide, from 32 to 37 g/lt of copper cyanide, from 13 to 17 g/lt of sodium carbonate, from 18 to 22 g/lt of Rochelle's salt and from 10 ml/it of ammonia.

68. The product-by-process as claimed in claim 62, wherein in the electroless brass-plating the solution must be at a temperature of between 40° C. and 80° C.

69. The product-by-process as claimed in claim 62, wherein in the electroless brass-plating step, the solution must be at a temperature of between 55° C. and 65° C.

70. The product-by-process as claimed in claim 62, wherein in the electroless brass-plating step, the pieces must be submerged in the solution for a time of 5 to 25 minutes.

71. The product-by-process as claimed in claim 62, wherein in the electroless brass-plating step, the pieces must be submerged in the solution for a time of 10 to 15 minutes.

72. The product-by-process as claimed in claim 62, wherein in the electroless brass-plating step, the solution is constantly stirred.

73. The product-by-process as claimed in claim 62, wherein in the electroless brass-plating step, the solution has a pH higher than 11.

74. The product-by-process as claimed in claim 62, wherein the second rinsing is carried out by submerging the piece in a countercurrent water stream at ambient temperature during at least 1 minute.

75. The product-by-process as claimed in claim 62, wherein the fixing treatment comprises submerging the piece in an acid solution containing boric acid at a concentration of between 7 to 27 g/lt having a pH lower than 5, and at a temperature of between 35° C. and 75°, for a time of 10 to 45 minutes under constant stirring.

76. The product-by-process as claimed in claim 62, wherein the fixing treatment comprises submerging the piece in an acid solution containing boric acid at a concentration of between 15 to 19 g/lt, having a pH lower than 4, and at a temperature of between 45 to 60° C., for a time of 20 to 30 minutes under constant stirring.

77. The product-by-process as claimed in claim 62, wherein the drying is carried out by exposing the piece to an air current at ambient temperature for at least 1 minute.

78. The product-by-process as claimed in claim 62, wherein the brass layer has a thickness of from 5 to 7 μm.
